(19) United States
(12) Patent Application Publication
(10) Pub. No.: US 2013/0238515 A1
(43) Pub. Date: Sep. 12, 2013

(54) METHOD OF GENERATING A CLUSTER HOUSING LAYOUT FROM BOUNDARY DATA OF A PLOT OF LAND

(71) Applicant: Mazlin B. Ghazali, Jaya (MY)

(72) Inventor: Mazlin B. Ghazali, Jaya (MY)

(21) Appl. No.: 13/808,344

(22) PCT Filed: Jul. 7, 2011
(86) PCT No.: PCT/IB2011/001898

§ 371 Date: May 6, 2013

(30) Foreign Application Priority Data
Jul. 7, 2010 (AU) 2010903016

(51) Int. Cl. G06Q 50/16

(52) U.S. Cl. CPC G06Q 50/165; G06Q 10/0631
USPC 705/315

(57) ABSTRACT

A method of generating a cluster housing layout from boundary data of a plot of land, the method including generating boundary lines for subdivision of the plot of land from the boundary data of the plot, subdividing the plot of land with subdivision lines which extend from the boundary lines and which define nodal points where the subdivision lines join the boundary lines or other subdivision lines, arranging a number of lots configured for a first type of cluster house at some of the nodal points and arranging a number of lots configured for a second type of cluster house between nodal points along at least some of the boundary lines or subdivision lines.

### FIELD OF THE INVENTION

This invention is concerned with a method of generating a cluster housing layout from boundary data of a plot of land. In particular, the method relates to arranging lots for cluster houses on a subdivision formed on the plot of land.

### BACKGROUND OF THE INVENTION

The process of dividing a large area of land into smaller areas is generally referred to as subdivision.

The basic technique for subdividing land starts with the arrangement of the access system. Often the road system is already in place and the subdivision is simply a process of cutting the land into narrower plots that continue to share the same (public) road. However, sometimes it is necessary to provide new roads entering the land to be subdivided. These roads are usually arranged according to some preconceived notion of how the land will then be subdivided, and they determine to a great extent the appearance of the final subdivision.

It is normal practice when creating a subdivision to create these roads first in a grid or other pattern, and to then divide the land so that each block has access to them.

This approach tends to cause the access ways to dominate the design and particularly in dense subdivisions when groups of buildings are attached to each other, cause the area occupied by roads to be large when compared to the land they give access to. This approach also tends to force the access ways to define the major social aspects of the development or the way in which the occupiers of the land will react with each other once the land is occupied. This forcing is at its most obvious when the lots are small, and is typical of very dense property developments such as row or terrace housing.

This forcing of social outcome is generally considered to be a negative by many sociologists and town planners. Most sociologists believe that it is important for human beings to have distinct private, or their own family space, semi-private, or space in which they mix with people they are familiar with and public space, or space in which they mix with strangers. It is important that private space is buffered by a layer of semi-private space. Many criminologists also agree that this sort of arrangement reduces crime rates and improves the security of residential communities.

Previous attempts to optimize land utilization in a subdivision project whilst retaining some sense of aesthetics generally have related to schemes for land subdivision, with or without schemes for arrangement of dwelling units on subdivided land. Other attempts at optimization of land usage have related to specific structural configurations of buildings to optimize occupant amenity in a high density environment.

Terrace or row house subdivision represents the densest form of landed property development currently available. However, in a row or terrace house development there is almost no semi-private space. Houses face directly onto a major street with only a small exposed yard separating them from it. The streets are through streets generally carrying traffic from a large radius around any individual's home. They are often used as alternative access to commuters passing through the area.

In order to overcome these undesirable outcomes, new forms of title have been created for residential, and to a limited extent, commercial developments. Often called “group title” or “cluster housing” these allow for the development of sub-neighbourhoods of land on which a cluster of dwellings or other buildings are built, grouped closely together leaving open spaces as common areas. The social outcome of cluster housing is considered by many to be better.

Generally speaking, housing units that sit on their own plots of land are called landed property. Such housing units may be detached, as in the bungalow, or be cluster houses. Common types of cluster houses are the semi-detached house, the terrace house and duplex, triplex, quadruplex, pentaplex, sextuplex or octaplex cluster houses which share a common party wall.

Given land boundaries that form irregular shapes and geographical features that form naturally, the rigid orthogonal grid arrangement may not be suitable. Moreover, in order to achieve more interesting designs, the orthogonal grid may be adjusted by curving or bending the roads and rows of houses to follow the natural contours and boundaries. Alternatively, the orthogonal grid may be replaced by a radial grid to achieve more interesting forms or the dimensions of the basic housing unit or row of units may be altered to better fit the land. Often, multiple grids are employed within a housing site and consequently various row housing layout patterns result from prior art housing subdivision methods.

It is an aim of the invention to overcome or alleviate at least some of the disadvantages of prior art methods for subdivision of land.

It would be desirable to provide a novel design method of planning land subdivision for cluster housing units with a layout that can overcome the social, aesthetic and environmental shortcomings of conventional row housing.

It would be desirable also to improve the pattern of roads and public spaces that serve dwelling units and to create better neighbourhoods which increase the value of a housing development.

### SUMMARY OF THE INVENTION

According to one aspect of the invention there is provided a method of generating a cluster housing layout from boundary data of a plot of land, the method including

generating boundary lines for subdivision of the plot of land from the boundary data of the plot;

subdividing the plot of land with subdivision lines which extend from the boundary lines and which define nodal points where the subdivision lines join the boundary lines or other subdivision lines;

arranging a number of lots configured for a first type of cluster house at some of the nodal points; and

arranging a number of lots configured for a second type of cluster house between nodal points along at least some of the boundary lines or subdivision lines.

The lots configured for the first type of cluster house are preferably lots which are configured for radial subdivision of cluster houses.

The lots configured for the second type of cluster house are preferably lots which are configured for orthogonal subdivision of cluster houses.

The lots configured for the first type of cluster house are preferably round and the lots configured for the second type of cluster house are preferably rectangular.

The lots are preferably subdivided into segments.

The method preferably includes trimming lots which fall outside the boundary by removing the segments which fall outside the boundary of the plot of land from these lots.

The cluster houses are preferably selected from duplex, triplex, quadriplex, pentaplex, sextuplex or octaplex structures or any combination thereof.

The method may include arranging the cluster houses on the plot of land.

According to another aspect of the invention there is provided a land subdivision whenever effected according to the foregoing method.

According to yet another aspect of the invention there is provided a method of generating a cluster housing layout from boundary data of a plot of land, the method including:

inputting into a processing device boundary data of the plot;

inputting boundary restrictions into the processing device to generate boundary lines for subdivision of the plot of land from the boundary data;

subdividing the plot of land, by input to the processing device, with subdivision lines which extend from the boundary lines and which define nodal points where the subdivision lines join the boundary lines or other subdivision lines;

selecting a lot configured for a first type of cluster house from a datastore of the processing device;

arranging a number of lots configured for a first type of cluster house on at least some of nodal points;

selecting a lot configured for a second type of cluster house from a datastore of the processing device; and

arranging a number of lots configured for a second type of cluster house between nodal points along at least some of the boundary lines or subdivision lines, thereby to provide a novel cluster housing layout.

The method may include the processing device trimming lots which fall outside the boundary by removing the segments which fall outside the boundary of the plot of land from these lots.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 is a diagrammatic top plan view of types of lots and cluster houses for use in the method of the present invention;

FIG. 2 is a diagrammatic top plan view of boundary data of a plot of land to be subdivided;

FIG. 3 is a diagrammatic top plan view of the plot of land of FIG. 2, including a boundary line generated in accordance with the invention;

FIG. 4 is a diagrammatic top plan view of the plot of land of FIG. 3, illustrating the plot of land subdivided by subdivision lines in accordance with the invention;

FIG. 5 is a diagrammatic top plan view of the plot of land of FIG. 4, illustrating a number of nodal cluster lots arranged on nodal points of the plot of land in accordance with the invention;

FIG. 6 is a diagrammatic top plan view of the plot of land of FIG. 5, illustrating nodal cluster lots of a different type arranged on the remaining nodal points of the plot of land in accordance with the invention;

FIG. 7 is a diagrammatic top plan view of the plot of land of FIG. 6, illustrating how the lots are trimmed in accordance with the invention;

FIG. 8 is a diagrammatic top plan view of a cluster house layout on the plot of land of FIG. 7, illustrating linear cluster lots arranged along boundary lines and subdivision lines in accordance with the invention;

FIG. 9 is a diagrammatic top plan view of the cluster housing layout of FIG. 8, illustrating half linear cluster lots arranged along boundary lines and subdivision lines;

FIG. 10 is a diagrammatic top plan view of the cluster housing layout of FIG. 9, including parks and roads formed on the plot of land; and

FIG. 11 is a diagrammatic flow diagram illustrating steps in the method of generating a cluster housing layout from boundary data of a plot of land accordance with the invention.

### DETAILED DESCRIPTION OF THE INVENTION

Embodiments of the present invention reside primarily in a method of generating a cluster housing layout from boundary data of a plot of land. Cluster housing refers to a grouping of housing units which are arranged about a common area. The method of subdivision of the present invention primarily includes arranging cluster houses on the subdivided plot of land. Accordingly, the method steps of subdivision have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order. Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

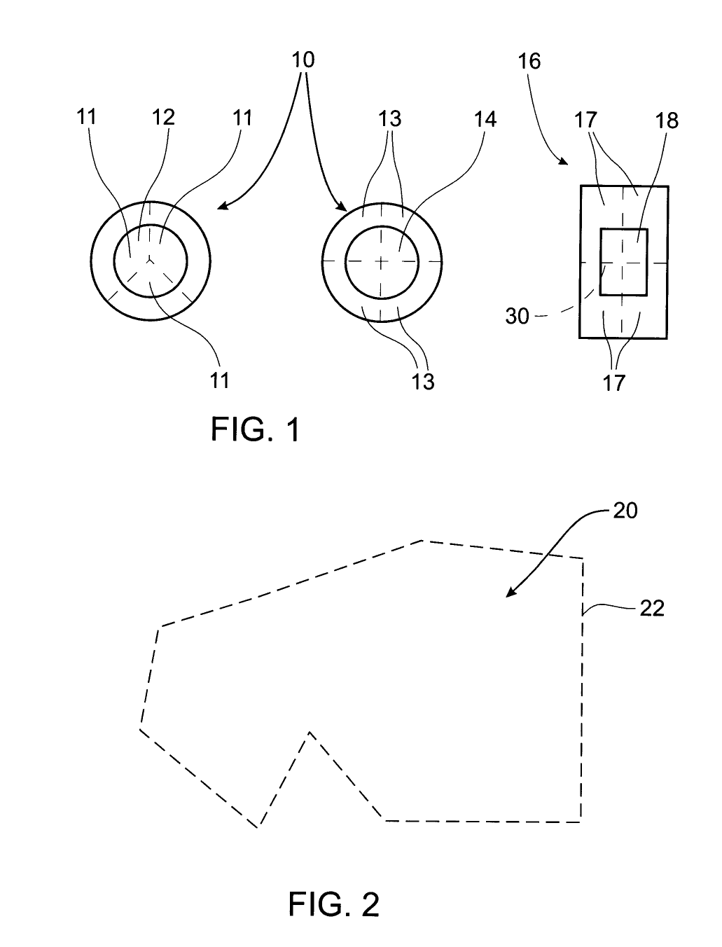

Referring to FIG. 1, there is shown two types of lots and cluster houses used in generating a cluster housing layout of the present invention.

The first type of lot is circular and referred to as a nodal cluster lot 10. The nodal cluster lot 10 has a nodal cluster house 12 or 14 located on the lot. The nodal cluster lot 10 of the nodal cluster house 12 is radially subdivided into three segments 11. The nodal cluster lot 10 of the nodal cluster house 14 is radially subdivided into four segments 13. The nodal cluster houses 12 and 14 are radially subdivided along the subdivisions of the nodal cluster lot 10. The nodal cluster house 12 is thus radially subdivided into three units and the cluster house 14 is radially subdivided into four units. The nodal cluster lots 10 and nodal cluster houses 12, 14 are configured to be accessed from three or more different roads.

The second type of lot is rectangular and referred to as a linear cluster lot 16. The linear cluster lot 16 has a quadruplex house 18 located on the lot. The linear cluster lot 16 is orthogonally subdivided into four segments 17 for the quadruplex house 18. The quadruplex house 18 is orthogonally subdivided into four units. The linear cluster lots 16 and quadruplex house 18 is configured to be accessed from two different roads.

The nodal cluster lot 10 and the linear cluster lot 16 are of different geometric configuration.

FIGS. 2 to 10 describe the sequence of subdividing a plot of land for cluster development and arranging lots on the plot of land.

Referring to FIG. 2, there is a shown a plot of land 20 having an irregular boundary 22. The broken lines indicating the boundary 22 is boundary data for the plot of land 20. The plot of land 20 may be any plot of land which is to be subdivided for cluster development. The boundary data for different plots of land will thus be different.

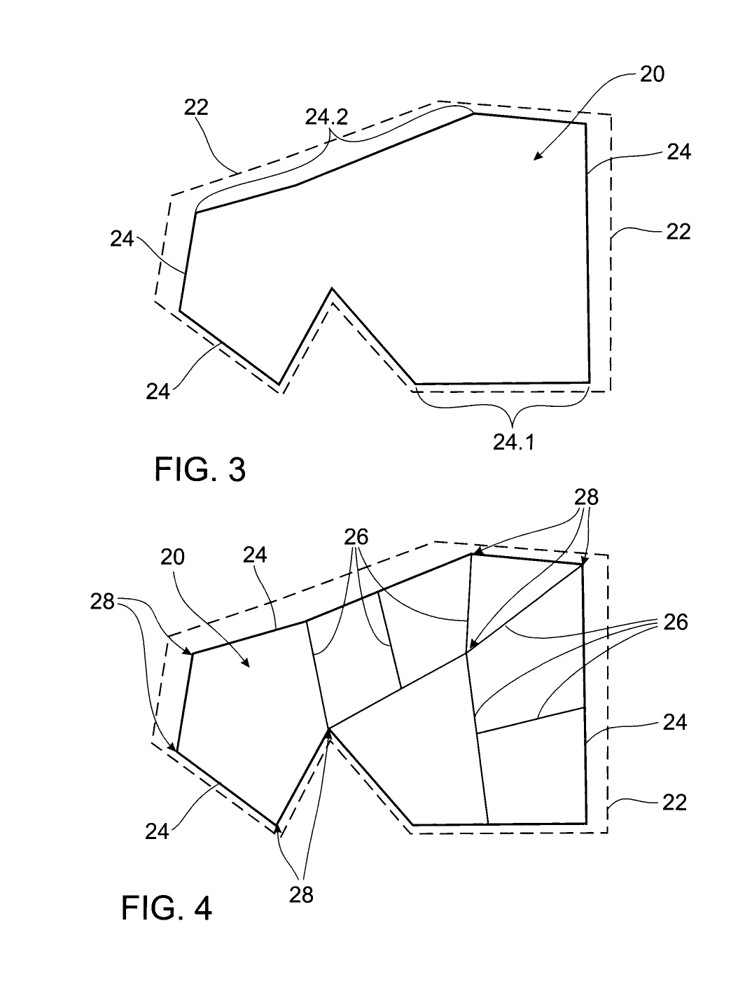

FIG. 3 illustrates boundary lines 24 generated for subdivision of the plot of land 20. The boundary lines 24 represent a rear wall line for cluster houses to be arranged on the plot of land 20. The boundary lines 24 are spaced a predetermined distance from the boundary 22, depending on boundary restrictions which apply to the plot of land 20. For example, a boundary line 24.1 of the boundary lines 24 is spaced 3 metres from the boundary 22 as this part of the plot 20 borders another piece of residential land. A boundary line 24.2 of the boundary lines 24 is spaced 6 metres from the boundary 22 as this part of the plot of land 20 borders a public road. The boundary lines 24 are drawn depending on boundary restrictions associated with the plot of land 20.

FIG. 4 illustrates subdivision lines 26 which are formed on the plot of land 20 inside the boundary lines 24. The subdivision lines 26 extend from the boundary lines 24. The subdivision lines 26 terminate where they join boundary lines 24 or other subdivision lines 26. Nodal points 28 are defined where the subdivision lines 26 join the boundary lines 24 or other subdivision lines 26. Nodal points 28 are also defined where various boundary lines 24 join.

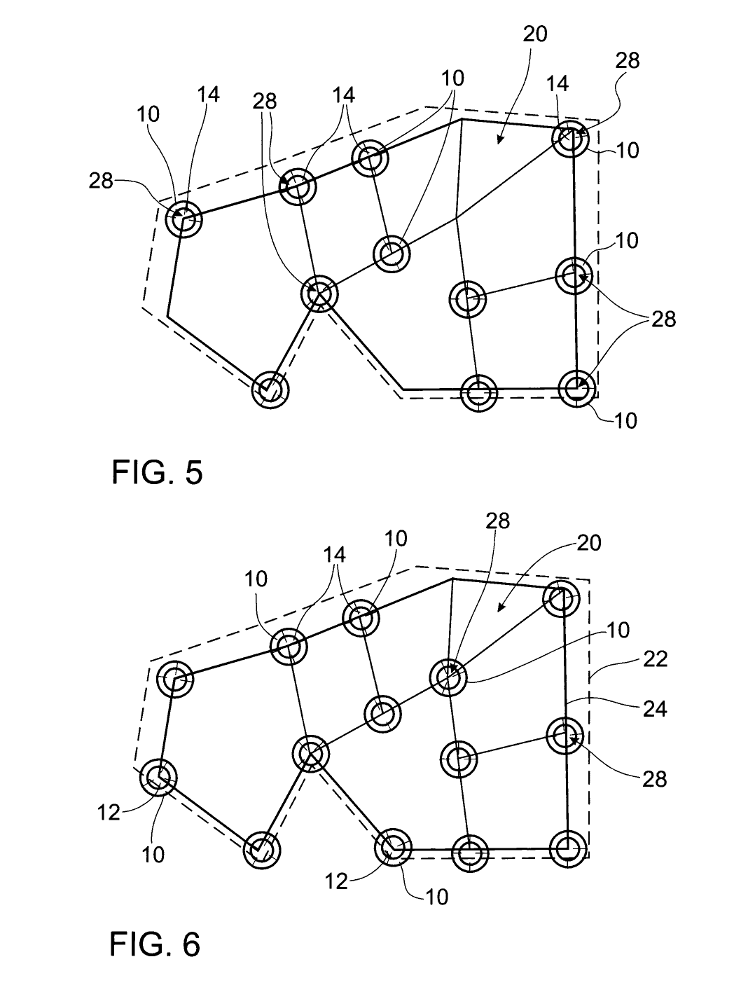

FIG. 5 illustrates a number of nodal cluster lots 10 for nodal cluster houses 14 formed at the nodal points 28. The centre of each nodal cluster lot 10 is located on a nodal point 28. Nodal cluster lots 10 with nodal cluster houses 14 are formed at only some of the nodal points 28.

FIG. 6 shows the subdivided plot of land 20 of FIG. 5, with nodal cluster lots 10 for nodal cluster houses 12 formed at the remaining nodal points 28.

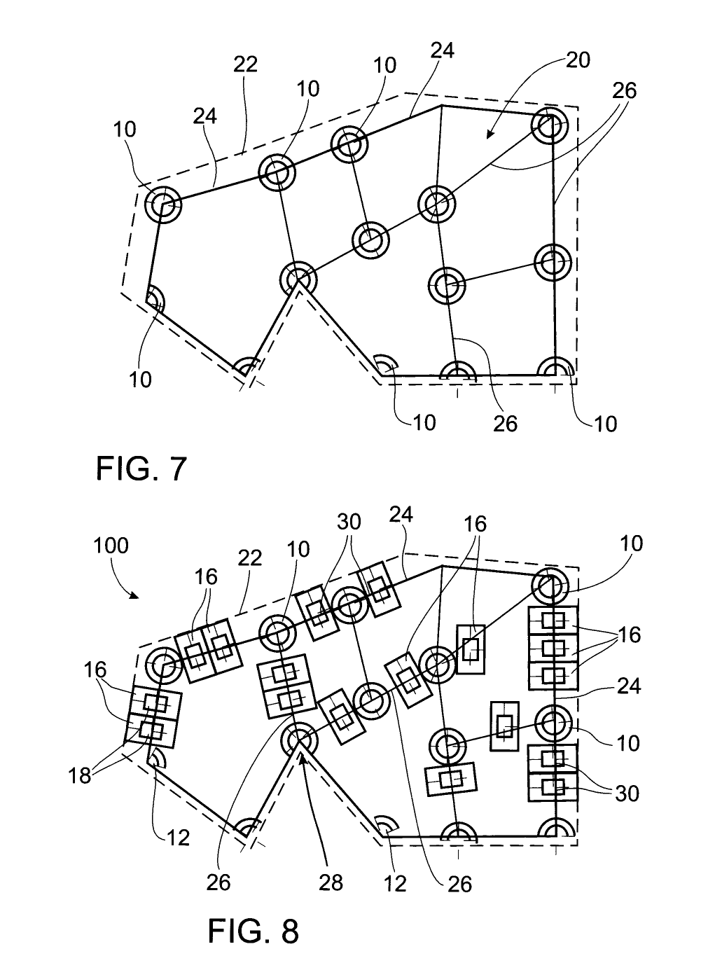

FIG. 7 illustrates how the nodal cluster lots 10 are trimmed. Segments of each nodal cluster lot 10 which fall outside of the boundary 22 as shown in FIG. 6 are removed from the nodal cluster lot 10. After trimming, none of the nodal cluster lots 10 fall outside the boundary 22 of the plot of land 20.

FIG. 8 illustrates a cluster housing layout 100 including a number of linear cluster lots 16 formed along the boundary lines 24 and the subdivision lines 26. The linear cluster lots 16 are arranged along the boundary lines 24 and the subdivision lines 26 and are spaced between the nodal cluster lots 10. A subdivision line 26 will generally have nodal cluster lots 10 at its opposite ends and linear cluster lots 16 between the nodal cluster lots 10. The linear cluster lots 16 are configured for quadruplex houses 18. The linear cluster lots 16 adjacent the boundary 22 is contiguous with the boundary 22. A rear wall line 30 of the quadruplex houses 18 is on the boundary lines 24 and the subdivision lines 26.

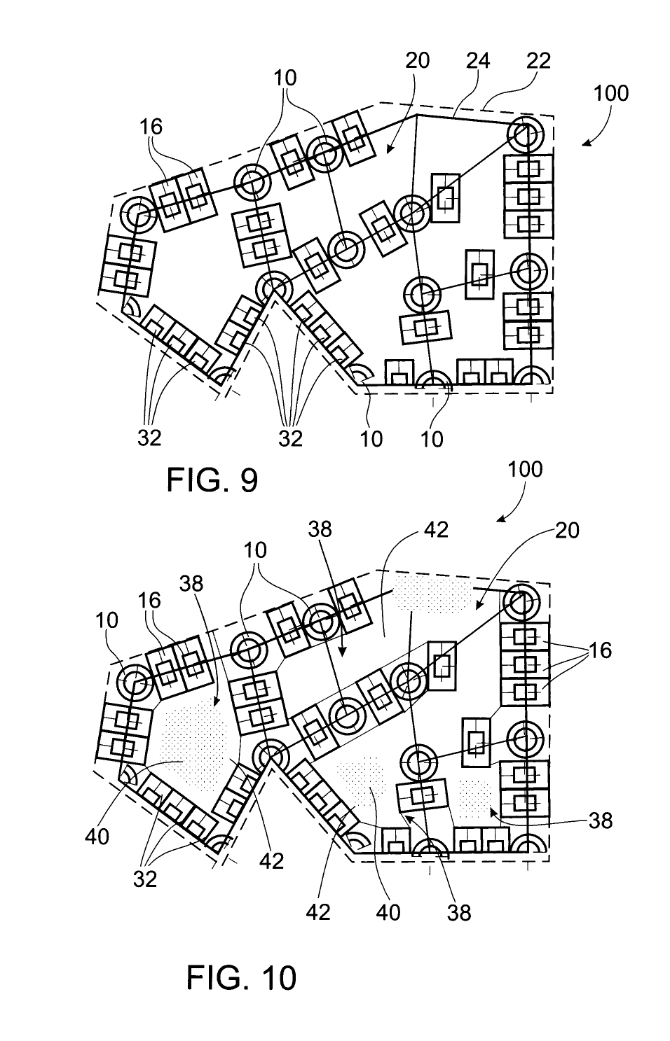

FIG. 9 illustrates a number of half linear cluster lots 32 formed along remaining parts of the boundary lines 24. The half linear cluster lots 32 are linear cluster lots 16 which are halved along rear wall lines 30 shown in FIG. 1. The half linear cluster lots 32 are located along the boundary lines 24 where segments of the linear cluster lots 16 would have fallen outside of the boundary 22. Alternatively, linear cluster lots 16 are formed along the remaining parts of the boundary lines 24 and trimmed to half linear cluster lots 32 where they fall outside the boundary 22.

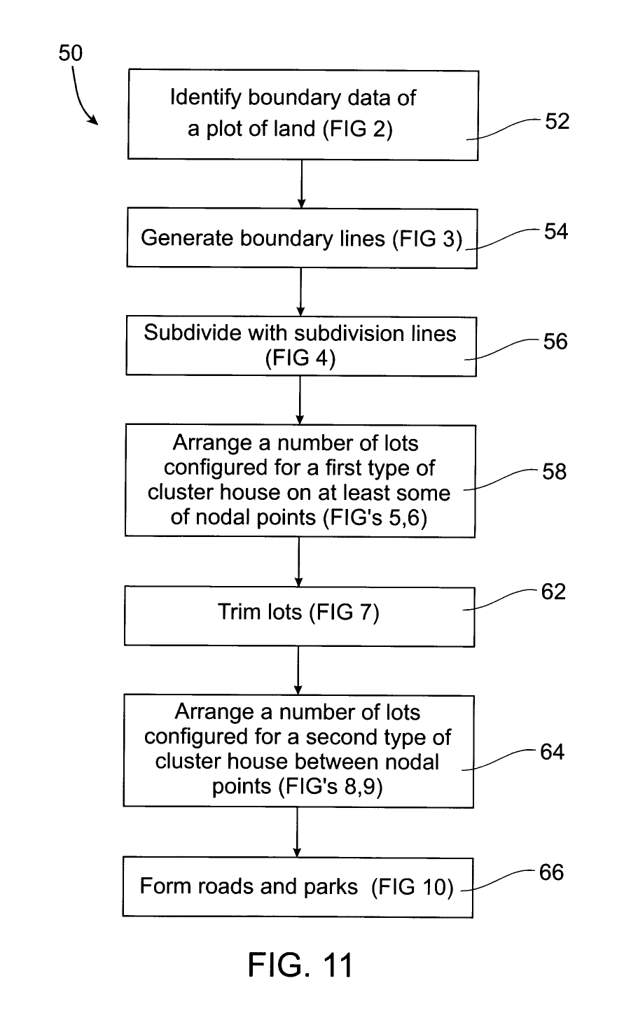

FIG. 10 illustrates the cluster housing layout 100 generated in accordance with an embodiment of the invention. The cluster housing layout 100 includes cluster lots 10, 16 and 32 arranged as cluster housing sub-neighbourhoods 38. The cluster lots 10, 16 and 32 of each sub-neighbourhood 38 surrounds a communal open space such as a park 40. Access ways such as roads 42 access each of the subdivisions 38.

FIG. 11 is a flow diagram 50 of the method described herein above. At a first step 52, boundary data of plot of land 20 is indentified as described with reference to FIG. 2. At a second step 54, boundary lines 24 are generated from the boundary data as described with reference to FIG. 3. At a third step 56 the plot of land 20 is subdivided by subdivision lines 26 as described with reference to FIG. 4. At a fourth step 60, nodal cluster lots 10 are arranged on nodal points 28 as described with reference to FIGS. 5 and 6. At a fifth step 62, the lots 10 are trimmed as described with reference to FIG. 7. At a sixth step 64, cluster housing layout 100 is formed by arranging linear cluster lots 16 between nodal points 28 as described with reference to FIGS. 8 and 9. At a last step 66, roads 42 and parks 40 are included in the layout 100 as described with reference to FIG. 10.

The method described above may be implemented on a processing device such as a computer having suitable software. Boundary data of the plot of land 20 will be input into the computer by an operator. The boundary data defines the boundary 22. Boundary restrictions are then input into the computer by the operator to generate boundary lines 24 for subdivision of the plot of land 20. The plot of land 20 is subdivided with subdivision lines 26 by inputs into the computer of where the subdivision lines 26 are to be formed. The operator selects nodal clusters lots 10 from a datastore of the processing device to arrange at the nodal points 28. The operator selects linear clusters lots 16 from a datastore of the processing device to arrange at between the nodal points 28 along some of the boundary lines 24 and subdivision lines 26. The processing device trims lots 10 which fall outside the boundary 22 by removing the segments which fall outside the boundary of the plot of land from these lots. Lastly, the operator defines roads 42 and parks 40 by input into the computer. The computer displays the subdivided plot of land 20 to the operator on a computer screen.

The method of the present invention provides a novel cluster housing layout 100 that can overcome the social, aesthetic and environmental shortcomings of conventional row housing. The pattern of roads 42 and public spaces 40 provided by the cluster housing layout 100 of the present invention creates better neighbourhoods which increase the value of a housing development.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A method of generating a cluster housing layout from boundary data of a plot of land, the method including
generating boundary lines for subdivision of the plot of land from the boundary data of the plot;
subdividing the plot of land with subdivision lines which extend from the boundary lines and which define nodal points where the subdivision lines join the boundary lines or other subdivision lines;
arranging a number of lots configured for a first type of cluster house at some of the nodal points; and
arranging a number of lots configured for a second type of cluster house between nodal points along at least some of the boundary lines or subdivision lines.

2. The method of claim 1, wherein the lots configured for the first type of cluster house are configured for radial subdivision of cluster houses.

3. The method of claim 1, wherein the lots configured for the first type of cluster house are round.

4. The method of claim 1, wherein the lots configured for the second type of cluster house are configured for orthogonal subdivision of cluster houses.

5. The method of claim 1, wherein the lots configured for the second type of cluster house are rectangular.

6. The method of claim 1, wherein the lots are subdivided into segments.

7. The method of of claim 1, including trimming lots which fall outside the boundary by removing the segments which fall outside the boundary of the plot of land from these lots.

8. The method of claim 1, including arranging the cluster houses on the plot of land.

9. The method of claim 8, including selecting cluster houses to be arranged on the plot of land from the group consisting of duplex, triplex, quadriplex, pentaplex, sextuplex or octaplex structures, or any combination from the group.

10. A land subdivision effected according to the method of subdivision of claim 1.

11. A method of generating a cluster housing layout from boundary data of a plot of land, the method including:
inputting into a processing device boundary data of the plot;
inputting boundary restrictions into the processing device to generate boundary lines for subdivision of the plot of land from the boundary data;
subdividing the plot of land, by input to the processing device, with subdivision lines which extend from the boundary lines and which define nodal points where the subdivision lines join the boundary lines or other subdivision lines;
selecting a lot configured for a first type of cluster house from a datastore of the processing device;
arranging a number of lots configured for a first type of cluster house on at least some of nodal points;
selecting a lot configured for a second type of cluster house from a datastore of the processing device; and
arranging a number of lots configured for a second type of cluster house between nodal points along at least some of the boundary lines or subdivision lines, thereby to provide a novel cluster housing layout.

12. The method of claim 11, including the processing device trimming lots which fall outside the boundary by removing the segments which fall outside the boundary of the plot of land from these lots.
